(19) United States
(12) Patent Application Publication
(10) Pub. No.: US 2010/0184003 A1
(43) Pub. Date: Jul. 22, 2010

(54) DENTAL TRANSFER FOR FIXING THE POSITION OF ENDOSSEOUS IMPLANTS IN DENTAL ARCHES

(76) Inventors: Matteo Danza, Pescara (IT); Patricia Abend Ensalem, Lyon (FR); Bichacho Nitzan, Tel Aviv (IL)

Correspondence Address: DENNISON, SCHULTZ & MACDONALD, 1727 KING STREET, SUITE 105, ALEXANDRIA, VA, 22314, US

(21) Appl. No.: 12/517,821

(22) PCT Filed: Dec. 29, 2006
(86) PCT No.: PCT/IB2006/003799

§ 371 Date: Jun. 5, 2009

(51) Int. Cl. A61C 8/00

(52) U.S. Cl. 433/173

(57) ABSTRACT

Dental transfer (10) for transferring to a impression material (61) the position and the orientation of at least one implant (4) located in a dental arch (50) of a patient. The dental transfer (10) provides in detail, a tubular element, or cannula (2), which engages at one end thereof (22) in a housing (41) present in the visible surface (42) of the implant (4). The tubular element (2) and the housing (41), having complementary shape, in particular polygonal surfaces, for example hexagonal, block the rotation of the tubular element (2). At the other end (23) of the tubular element (2), a sleeve (3) is mounted having an axial hole (31) which also has hexagonal cross section complementary to the tubular element (2). Therefore, the sleeve (3) can freely translate along the tubular element (2), but cannot rotate with respect to it. This way, the sleeve (3) translates along the tubular element (2) up to approach the visible surface of the implant (4). The dental transfer (10) is completed by a fastening screw (1) equipped with a screw threaded end (13) and an enlarged head (11), knurled at a portion thereof (12) for assisting the grip by an operator.

### FIELD OF THE INVENTION

The present invention relates to a dental device and, in particular, it relates to a dental transfer for fixing the position of endosseous implants in dental arches.

### DESCRIPTION OF THE PRIOR ART

During implant rehabilitative therapies, at the end of the recovery period and at start of osseointegration of the implants, for the construction of implant abutments and implant structures for supporting dental prosthesis, it is necessary to fix with extreme precision the perfect position, in the three dimensions, of the implants put in the dental arches. This procedure is presently carried out with a so called “pick-up” technique and provides a device called dental transfer.

This procedure consists of coupling the dental transfers to the implants located in the alveolar crests of the dental arches.

Normally a dental transfer provides a retention element with variable retaining shape that is adapted to remain embedded in an impression material put in a special impression tray. The perfect position of the implants depends on the dental technicians that assemble them on dental models.

The transfer, in particular, has an end with hexagonal shape complementary to the inner hexagon of the implant that is integral to the body of the same. The transfer is connected to the implant with a long screw.

More in detail, the screw crosses the transfer for all its length up to engaging with the inner thread of the implant, adapted to receive the fastening screw of the implant abutment. This way, the tightened screw causes a perfect matching of the transfer to the implant. The matching between transfer and implant prevents from a relative movement of the two coupled elements.

The opposite end of the screw is long enough to exceed several mm from the base of the transfer so that they can protrude from the hole made on the impression tray to allow unscrewing when the material is hardened.

The procedure for fixing the position of the implant consists of fixing the transfer to the implant and assigning, the position of the transfer to the other structures of the dental arches, i.e. implant, alveolar environment, gums, teeth, etc.

The above described assignment is made through a perforated individual impression tray, specially built, which contains the impression material and incorporates and includes the transfer in the desired position, where it is located when it is coupled to the implants. When, in fact, the impression material changes its status from viscous to compact after polymerization, the screw that blocks the transfer to the implant is unscrewed and the impression tray that contains the hardened impression material is removed, with the transfer incorporated in a position complementary to the implant.

If inserted implants are not parallel to each other, the transfers are also not parallel to each other, since they reflect the orientation of the implants.

The hexagon of a transfer, coupled to the inner hexagon of the implant, which has a depth of 4.5 mm, will come out without friction only if the two systems are parallel to each other and if they share the disengagement trajectory. If the implants whose position is to be fixed are more than one, and are not perfectly parallel to each other, the hexagons of the transfer will come out from those of the implants, being subject necessarily to a deformation, owing to the elasticity of the impression material. The real position is then normally re-established by the elastic recovery of the material.

However, the elastic recovery, in particular, in case of disparallel condition, is not exact in a micrometric way. Therefore, the error is transferred unavoidably to the master model of the dental laboratory that is obtained by casting plaster around the analogs, which have been coupled to the transfer when the impression has been withdrawn by the mouth, and that are the replica of the implants whose position has to be fixed.

### SUMMARY OF THE INVENTION

It is then a feature of the present invention to provide a dental transfer for fixing the position of endosseous implants in dental arches to avoid measurement errors in the position of the implants.

It is another feature of the invention to provide such a dental transfer capable of making easier the step of determining the position of the dental implants by an operator.

It is also a feature of the invention to provide such a dental transfer that has a low vertical encumbrance.

It is a particular feature of the invention to provide a dental transfer for fixing the position of the implants with high precision also in case of implants with a certain rate of disparallel condition.

It is a further feature of the invention to provide a dental transfer that allows an easy manual use by an operator.

This and other features are accomplished with one exemplary dental transfer, for transferring to an impression material in an impression support the position of a dental implant, said dental implant being already located in dental arches of a patient and having a housing, whose main feature is of providing:
a tubular element having an end engageable in the housing in a rotationally blocked way, said tubular element having the other end protruding from the implant;
a sleeve having an axial hole adapted to engage in a rotationally blocked way with the tubular element to approach to the implant, said tubular element being withdrawable from said sleeve when the latter is blocked in the hardened impression material in the impression support;
a fastening screw adapted to cross the tubular element for all its length up to fit a screw threaded portion of the housing, said fastening against said implant.

Advantageously, the portion of the tubular element penetrated by the sleeve has polygonal cross section, preferably hexagonal, which prevents it from a mutual rotation.

Preferably, the tubular element couples with the housing of the implant by means of surfaces with polygonal complementary cross section that prevents it from rotation.

In particular, the fastening screw may have a enlarged head adapted to provide a handgrip for an operator.

Advantageously, the enlarged head of the fastening screw has a knurled portion that makes easier a grip to the operator. This allows screwing/unscrewing easily the fastening screw without the need of using a key, commonly used in dental transfers of prior art, which requires considerable vertical space for being operated.

In addition, or alternatively, to the knurled portion, the enlarged head of the fastening screw can be equipped at an end portion with a recess adapted to fit a common prosthetic jack of prior art, for example of the type having square cross section, for tightening and untightening it.

The tubular element, in use, has an end inserted in the implant and the other end protruding from the sleeve of a determined length adapted to engage with a ring-shaped recess made in the enlarged head of the fastening screw.

Preferably, the inner side face of the tubular element has a screw threaded portion complementary to the thread of the fastening screw.

In particular, when disassembling the dental device the fastening screw is unscrewed from the screw threaded housing, acting on the enlarged head, and is screwed in the tubular element at the screw threaded portion. This way, the tubular element can be easily extracted from the housing of the implant causing it to pass through the sleeve while it is steadily fixed to the hardened impression material. This way, it is avoided that the tubular element can accidentally fall in the mouth of the patient and the dentist can work in a maximum safety.

In particular, the sleeve has a frustum conical end adapted to engage with a bead, for example at an angle of 45°, made on the visible surface of the implant.

Advantageously, the sleeve has at least one circumferential recess, or groove, which has a retaining shape suitable to ensure a steady fastening in the hardened impression material.

In particular, the enlarged head of the fastening screw at the end portion has a recess adapted to fit a common prosthetic jack of prior art to provide the tightening or untightening of the screw.

### BRIEF DESCRIPTION OF THE DRAWINGS

The invention will be made clearer with the following description of an exemplary embodiment thereof, exemplifying but not limitative, with reference to the attached drawings wherein:

FIG. 1 shows an exploded perspective view of a dental transfer for fixing the position of endosseous implants in dental arches, according to the invention;

FIG. 2 shows a perspective elevation front view of the dental transfer of FIG. 1 in an assembled configuration;

FIGS. 3 to 8 show diagrammatically a perspective view of a possible succession of steps through which the registration of the position can be made of a dental implant with the dental transfer of FIG. 1;

FIGS. 9 to 11 show diagrammatically partially cross sectioned views of a possible succession of steps through which the dental transfer of FIG. 1 can be removed from the position registration configuration of the dental implant;

FIG. 12 shows finally a plurality of dental transfers of FIG. 1 used at the same time.

### DESCRIPTION OF PREFERRED EXEMPLARY EMBODIMENTS

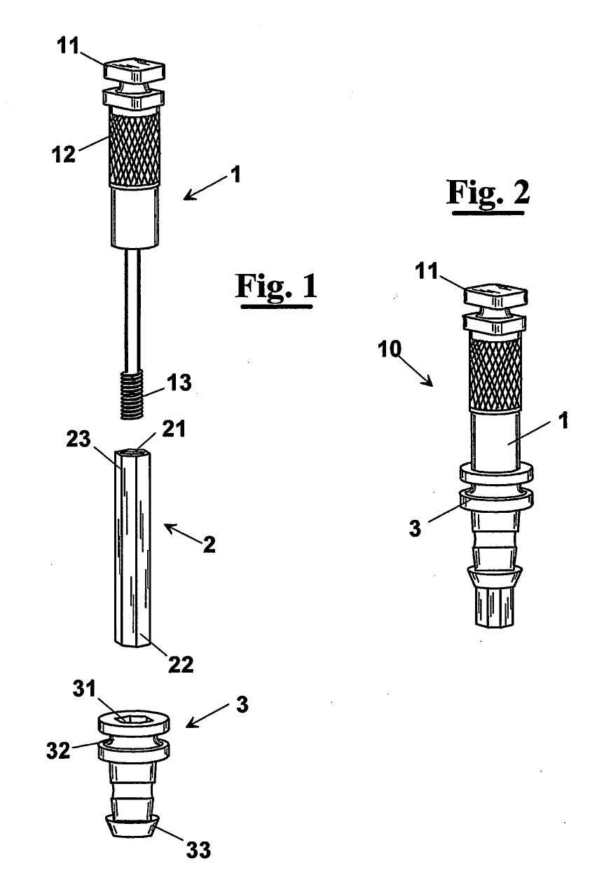

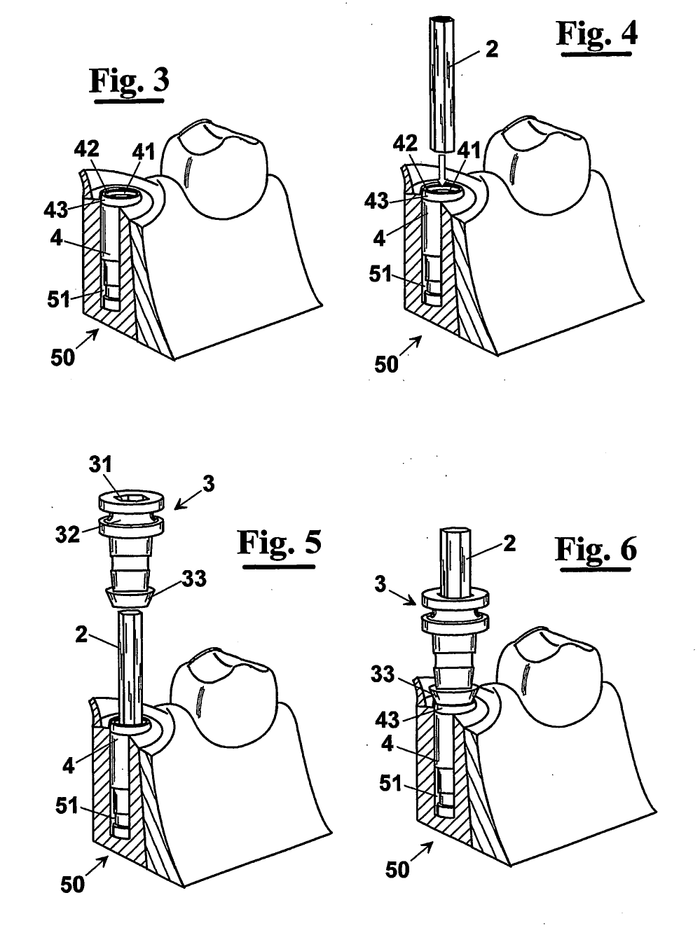

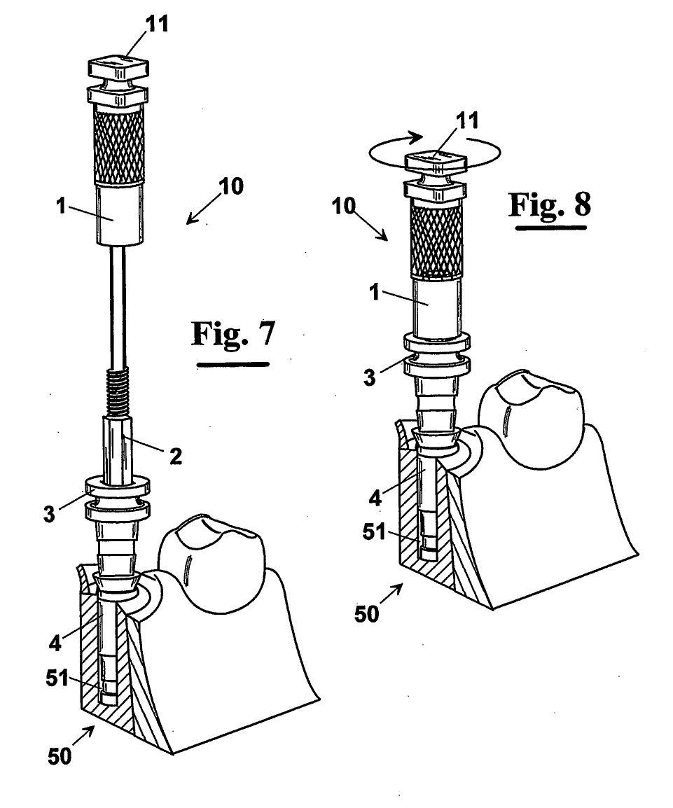

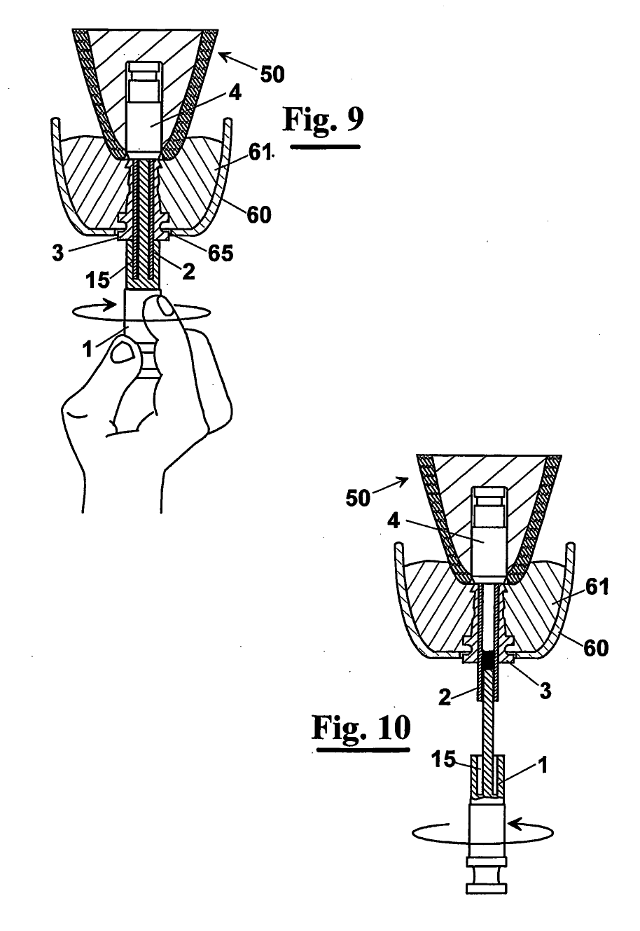

In FIGS. 1 to 11 a dental transfer 10 is shown, according to the invention, for transferring to an impression material 61 the position and the orientation of at least one implant 4 located in the dental arch 50 of a patient.

Dental transfer 10 provides, in detail, a tubular element, or cannula 2, which engages, at one end thereof 22, with a housing 41 made on the visible surface 42 of implant 4 (FIG. 4). Tubular element 2 and housing 41, having shape complementary to each other, have, in particular, surfaces with polygonal cross section, for example hexagonal, which block the rotation of tubular element 2. The latter has, in particular, hexagonal cross section for all its length.

At the other end 23 of tubular element 2, a sleeve 3 is mounted having an axial hole 31 which also has hexagonal cross section complementary to tubular element 2 (FIG. 5). Therefore, sleeve 3 can freely translate along tubular element 2, but cannot rotate with respect to it. This way, sleeve 3 translates along tubular element 2 up to the visible surface of implant 4.

Dental transfer 10 is completed by a fastening screw 1 equipped with a screw threaded end 13 and an enlarged head 11, knurled at a portion 12 for the grip of an operator.

Fastening screw 1, in use crosses tubular element 2 for all its length up to screwing at screw threaded end 13 in screw threaded housing 41 of implant 4, to it complementary. This way, sleeve 3 and tubular element 2 are locked in a correct working position at which the frustum conical end 33 of sleeve 3 engages in a conical bead 43 of implant 4.

In such an assembled configuration, the portion of tubular element 2 protruding from sleeve 3 is housed in a ring-shaped recess 15 made on a face 16 of enlarged head oriented towards sleeve 3. This way, acting on fastening screw 1 the dentist can reach easily a precise matching between tubular element 2 and implant 4 and therefore an intimate and precise approach of sleeve 3 to implant 4.

The enlarged head 11 is caused to pass through an opening 65 of a common individual impression support 60 in which an impression material 61 is put capable of turning) from a viscous status to a hardened status. To ensure a steady fastening in impression material 61, sleeve 3 comprises, in particular, a retaining shape comprising a circumferential recess, or groove 32, which gives a high capacity of being incorporated in impression material 61.

As shown in detail in the enlarged view 100 of FIG. 11, the inner side face of tubular element 2 has a screw threaded portion 25 complementary to that of end 13 of fastening screw 1. In particular, when disassembling the dental transfer 10, fastening screw 1 is unscrewed from screw threaded housing 41 and screwed into tubular element 2 at screw threaded portion 25. This way, tubular element 2 can be easily extracted from housing 41 and caused to pass through sleeve 3 whereas this is steadily fixed to impression material 61. This avoids that tubular element 2 can accidentally fall in the mouth of the patient during its removal and assists then the dentist to work at maximum safety.

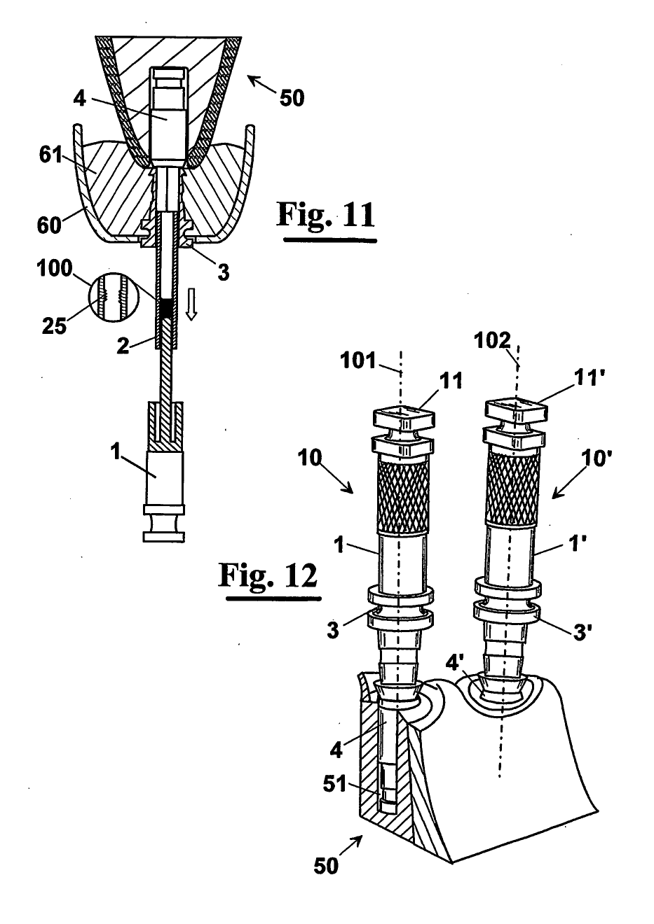

Dental transfer 10, as above described, is particularly effective in case of more than one dental implant, for example two implants 4, 4′ installed in a dental arch 50 of a patient and having a certain rate of disparallel condition (FIG. 12). In this case, in fact, the use of a dental transfer of prior art would cause unavoidably a certain rate of inaccurateness when fixing the position of the implant. In fact, when the hexagon of the transfer is disengaged from the housing of the implant, it is subject to deformation because of the elasticity of the impression material 61.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

What is claimed is:

1. Dental transfer for transferring to an impression material in an impression support the position of a dental implant, said dental implant being already located in a dental arch of a patient and having a housing, comprising:
a tubular element having an end engageable in said housing in a rotationally blocked way, said tubular element having the other end protruding from said implant;
a sleeve having an axial hole adapted to engage in a rotationally blocked way with said tubular element to approach said implant, said tubular element being withdrawable from said sleeve when the latter is blocked in the hardened impression material in said impression support; and
a fastening screw adapted to cross the tubular element for all its length up to fit a screw threaded portion of said housing, said fastening screw forcing said sleeve in a correct position against said implant.

2. Dental transfer, according to claim 1, wherein the portion of the tubular element that penetrates said sleeve has polygonal cross section, preferably hexagonal, which prevents them from a mutual rotation.

3. Dental transfer, according to claim 1, wherein said tubular element fits said housing of said implant by means of surfaces with polygonal complementary cross section that prevents it from rotation.

4. Dental transfer, according to claim 1, wherein said fastening screw has an enlarged head adapted to provide a handgrip for an operator.

5. Dental transfer, according to claim 4, wherein said end protruding from said tubular element emerges from said sleeve for engaging with a ring-shaped recess made in said enlarged portion of said fastening screw.

6. Dental transfer, according to claim 1, wherein said tubular element at the inner side face has a screw threaded portion complementary to the thread of said fastening screw.

7. Dental transfer, according to claim 1, wherein said sleeve has a frustum conical end adapted to engage with a bead made on a visible surface of said implant.

8. Dental transfer, according to claim 1, wherein said sleeve has a retaining shape suitable to ensure a steady fastening in the impression material.

9. Dental transfer, according to claim 8, wherein said sleeve has at least one groove suitable to ensure a steady fastening in the hardened impression material.

10. Dental transfer, according to claim 4, wherein said enlarged head of said fastening screw has a knurled portion that assists its grip.

11. Dental transfer, according to claim 4, wherein said enlarged head of said fastening screw at the end portion has a recess adapted to fit a common prosthetic jack of prior art to provide the tightening and untightening of said screw.
